(19) United States
(12) Patent Application Publication
(10) Pub. No.: US 2023/0249730 A1
(43) Pub. Date: Aug. 10, 2023

(54) DOUBLE-DECKER COLLAPSIBLE CART

(71) Applicant: Zhejiang Daofeng Electronic Technology Co., Ltd., Jinhua (CN)

(72) Inventor: Pengfei TONG, Jinhua (CN)

(21) Appl. No.: 18/135,122

(22) Filed: Apr. 15, 2023

(30) Foreign Application Priority Data
Mar. 14, 2023 (CN) 202320478771.6

(51) Int. Cl. B62B 3/02; B62B 3/00; B62B 5/06

(52) U.S. Cl. CPC B62B 3/022; B62B 3/002; B62B 5/068; B62B 2205/06

(57) ABSTRACT

A double-decker collapsible cart includes a front frame, a rear frame, a first folding mechanism, a second folding mechanism, and front and rear wheels. The second folding mechanism includes a front-upper base frame and a rear-upper base frame articulated with each other, a front-lower base frame and a rear-lower base frame articulated with each other, and a support linkage rod. The front-upper base frame and the front-lower base frame are hinged to the front frame, and the rear-upper base frame and the rear-lower base frame are hinged to the rear frame. One end of the support linkage rod is connected to a joint of the front-upper base frame and the rear-upper base frame, and the other end is connected to a joint of the front-lower base frame and the rear-lower base frame. A bottom cover is disposed on the front-upper base frame and/or the rear-upper base frame.

### CROSS-REFERENCE TO RELATED APPLICATIONS

This application claims the benefit of priority from Chinese Patent Application No. 202320478771.6, filed on Mar. 14, 2023. The content of the aforementioned application, including any intervening amendments thereto, is incorporated herein by reference in its entirety.

### TECHNICAL FIELD

This application relates to outdoor collapsible carriers, and more particularly to a double-decker collapsible cart.

### BACKGROUND

A carrying tool is often used to facilitate transportation of goods in self-driving tour or camping. However, ordinary carrying tools are only suitable for even roads, and are not suitable for uneven country roads. Moreover, they generally struggle with large folded volume, unstable transportation, and heavy weight. In order to solve the above problems, Chinese Patent No. 209634530U discloses a folding shopping cart. In use, a storage bag is fixed on a basket of the shopping cart, and the shopping cart can be rapidly folded by means of the front and rear folding frames. The shopping cart has a small folded size, and is convenient to carry and store. However, all goods are stacked in the basket, and cannot be placed separately. Especially, this shopping cart fails to enable the separate storage of food and aquatic products which are easy to be damaged and contaminated during transportation. To solve the above problems, extensive attempts have been made, but so far there are no ideal products available.

### SUMMARY

In view of the deficiencies in the prior art, this application provides a double-decker collapsible cart with a simple and reasonable structure, easy folding operation, stable and reliable transportation, and small folded volume, which enables the separate and convenient placement of different items.

Technical solutions of this application are described as follows.

This application provides a double-decker collapsible cart, including:

a front frame;

a rear frame;

a first folding mechanism;

a second folding mechanism for double-decker linkage folding;

a front wheel; and

a rear wheel;

wherein the second folding mechanism includes a front upper base frame, a rear upper base frame, a front lower base frame, a rear lower base frame, and a support linkage rod; the front upper base frame is hingedly connected with the rear upper base frame; and the front lower base frame is hingedly connected with the rear lower base frame;

the front upper base frame and the front lower base frame are hingedly connected to the front frame; the rear upper base frame and the rear lower base frame are hingedly connected to the rear frame; one end of the support linkage rod is hingedly connected to a connection between the front upper base frame and the rear upper base frame; and the other end of the support linkage rod is hingedly connected to a connection between the front lower base frame and the rear lower base frame; and

at least one of the front upper base frame and the rear upper base frame is provided with an openable bottom cover.

In an embodiment, both sides of the double-decker collapsible cart are each provided with the first folding mechanism; the first folding mechanism includes a front X-shaped folding frame and a rear X-shaped folding frame; and the front X-shaped folding frame is hingedly connected with the rear X-shaped folding frame;

an upper end of a front portion of the front X-shaped folding frame at one side is connected to an upper end of a front portion of the front X-shaped folding frame at the other side; and a lower end of the front portion of the front X-shaped folding frame at one side and a lower end of the front portion of the front X-shaped folding frame at the other side are hingedly connected to the front frame;

an upper end of a rear portion of the rear X-shaped folding frame at one side is connected to an upper end of a rear portion of the rear X-shaped folding frame at the other side; and a lower end of the rear portion of the rear X-shaped folding frame at one side and a lower end of the rear portion of the rear X-shaped folding frame at the other side are hingedly connected to the rear frame; and

a connecting shaft is connected between a lower connection between the front X-shaped folding frame and the rear X-shaped folding frame at one side and a lower connection between the front X-shaped folding frame and the rear X-shaped folding frame at the other side; and the connecting shaft is configured to support the front lower base frame and the rear lower base frame when the double-decker collapsible cart is unfolded.

In an embodiment, a first connecting piece is hingedly connected between the front X-shaped folding frame and the front frame; and

a second connecting piece is hingedly connected between the rear X-shaped folding frame and the rear frame.

In an embodiment, the front frame is provided with an articulation seat; the articulation seat is connected with a pull rod; and the pull rod is configured to be pulled to allow the double-decker collapsible cart to move.

In an embodiment, the front frame is provided with two front wheels through a first wheel frame; and the rear frame is provided with two rear wheels through a second wheel frame.

Compared to the prior art, this application has the following beneficial effects.

The double-decker collapsible cart provided herein includes a linkage folding mechanism, which includes articulated front and rear upper base frames, articulated front and rear lower base frames, and a support linkage rod. The front-upper base frame and the front-lower base frame are hinged to the front frame, and the rear-upper base frame and the rear-lower base frame are hinged to the rear frame. One end of the support linkage rod is connected to a joint of the front-upper base frame and the rear-upper base frame, and the other end of the support linkage rod is connected to a joint of the front-lower base frame and the rear-lower base frame. Based on this design, the double-decker linkage folding is enabled. Moreover, at least one of the front and rear upper base frames is provided with an openable bottom cover, such that different items can be separately stored and removed. When folding, the front and rear upper base frames are lifted from the middle, and under the action of the support linkage rod, the front and rear lower base frames are driven to be folded quickly. The collapsible cart has a small folded volume, which is convenient to carry and store. When the collapsible cart is unfolded, the connecting shaft plays a role in supporting the front and rear lower base frames, and the support linkage rod plays a role in supporting the front and rear upper base frames, allowing for good rigidity, stability and reliability, and large loading capacity.

### BRIEF DESCRIPTION OF THE DRAWINGS

FIG. 1 is a structural diagram of a double-decker collapsible cart according to one embodiment of the present disclosure when unfolded;

FIG. 2 is a structural diagram of the double-decker collapsible cart according to one embodiment of the present disclosure in an unfolded state with a bottom cover opened;

FIG. 3 is a top view of the double-decker collapsible cart according to one embodiment of the present disclosure when unfolded;

FIG. 4 is a structural diagram of the double-decker collapsible cart according to one embodiment of the present disclosure in a half-folded state; and

FIG. 5 is a structural diagram of the double-decker collapsible cart according to one embodiment of the present disclosure when folded.

In the figures: 1—pull rod; 2—front frame; 3—front upper base frame; 4—first connecting piece; 5—bottom cover; 6—front X-shaped folding frame; 7—rear upper base frame; 8—rear X-shaped folding frame; 9—rear frame; 10—second connecting piece; 11—articulation seat; 12—first wheel frame; 13—front wheel; 14—front lower base frame; 15—connecting shaft; 16—support linkage rod; 17—rear lower base frame; 18—rear wheel; and 19—second wheel frame.

### DETAILED DESCRIPTION OF EMBODIMENTS

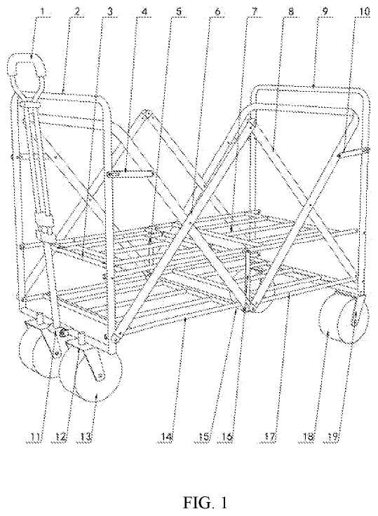

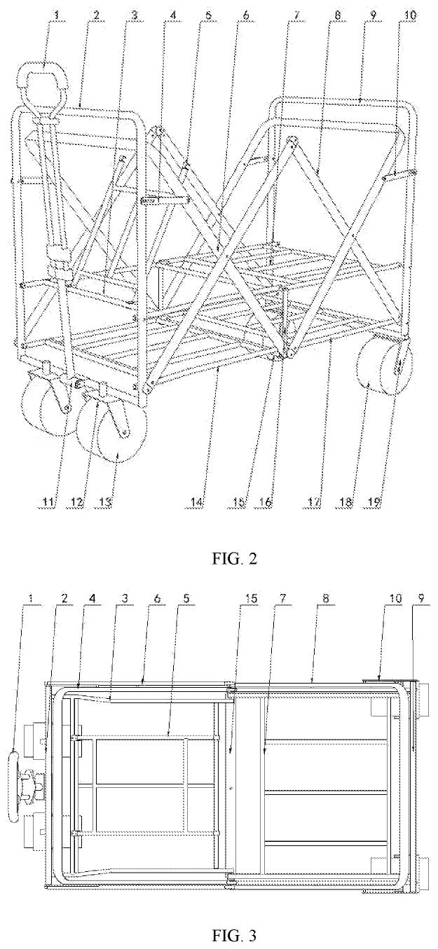

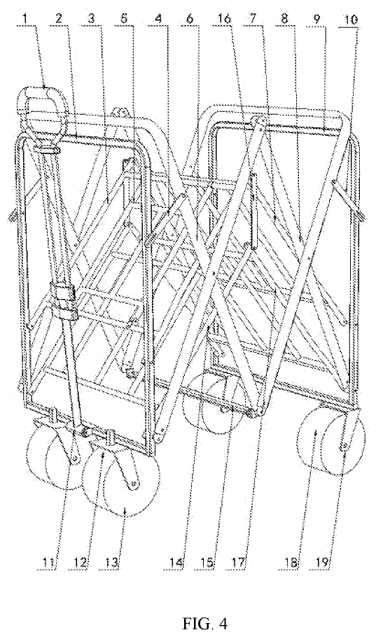

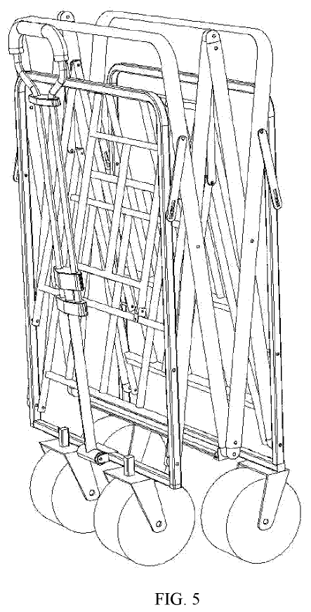

As shown in FIGS. 1 to 5, a double-decker collapsible cart includes a front frame 2, a rear frame 9, a first folding mechanism, a second folding mechanism for double-decker linkage folding, a front wheel 13, and a rear wheel 18.

The second folding mechanism includes a front upper base frame 3, a rear upper base frame 7, a front lower base frame 14 and a rear lower base frame 17, and a support linkage rod 16. The front upper base frame 3 is hingedly connected with the rear upper base frame 7, and the front lower base frame 14 is hingedly connected with the rear lower base frame 17. The front upper base frame 3 and the front lower base frame 14 are hingedly connected to the front frame 2. The rear upper base frame 7 and the rear lower base frame 17 are hingedly connected to the rear frame 9. One end of the support linkage rod 16 is hingedly connected to a connection between the front upper base frame 3 and the rear upper base frame 7, and the other end of the support linkage rod 16 is hingedly connected to a connection between the front lower base frame 14 and the rear lower base frame 17. At least one of the front upper base frame 3 and the rear upper base frame 7 is provided with an openable bottom cover 5, so that the items on the front lower base frame 14 and/or the rear lower base frame 17 are easily taken out. According to the actual situation, the bottom cover 5 can be disposed in the front upper base frame 3, can also be disposed in the rear upper base frame 7, or simultaneously disposed on the front upper base frame 3 and the rear upper base frame 7. The connection method of the bottom cover 5 may be hinged or disassembled. In this embodiment, the bottom cover 5 is hinged on the front upper base frame 3.

In order to facilitate folding and improve the stability and reliability of structure, both sides of the double-decker collapsible cart are each provided with the first folding mechanism, the first folding mechanism includes a front X-shaped folding frame 6 and a rear X-shaped folding frame 8, and the front X-shaped folding frame 6 is hingedly connected with the rear X-shaped folding frame 8. An upper end of a front portion of the front X-shaped folding frame 6 at one side is connected to an upper end of a front portion of the front X-shaped folding frame 6 at the other side by a front crossbar. A lower end of the front portion of the front X-shaped folding frame 6 at one side and a lower end of the front portion of the front X-shaped folding frame 6 at the other side are hingedly connected to the front frame 2. An upper end of a rear portion of the rear X-shaped folding frame 8 at one side is connected to an upper end of a rear portion of the rear X-shaped folding frame 8 at the other side. A lower end of the rear portion of the rear X-shaped folding frame 8 at one side and a lower end of the rear portion of the rear X-shaped folding frame 8 at the other side are hingedly connected to the rear frame 9. A connecting shaft 15 is connected between a lower connection between the front X-shaped folding frame 6 and the rear X-shaped folding frame 8 at one side and a lower connection between the front X-shaped folding frame 6 and the rear X-shaped folding frame 8 at the other side. The connecting shaft 15 can not only improve the stability of the frame, but also support the front lower base frame 14 and the rear lower base frame 17 when the double-decker collapsible cart is unfolded, thereby improving the bearing capacity.

In order to achieve linkage, a first connecting piece 4 is hingedly connected between the front X-shaped folding frame 6 and the front frame 2. A second connecting piece 10 is hingedly connected between the rear X-shaped folding frame 8 and the rear frame 9.

For ease of use, the front frame 2 is provided with an articulation seat 11, the articulation seat 11 is connected to a pull rod 1, and the pull rod 1 is configured to be pulled to allow the double-decker collapsible cart to move. The front frame 2 is provided with two front wheels 13 by a first wheel frame 12, and the rear frame 9 is provided with two rear wheels 18 by a second wheel frame 19.

In use, a storage bag is fixed on the frame, which can prevent the items from falling off while the collapsible cart is moving. When the collapsible cart is folded, the connection of the front upper base frame 3 and the rear upper base frame 7 are lifted, and the front upper base frame 3 and the rear upper base frame 7 are folded upwards. Driven by the support linkage rod 16, the front lower base frame 14 and the rear lower base frame 17 are synchronously folded upwards. Driven by the front upper base frame 3, the rear upper base frame 7, the front lower base frame 14, and the rear lower base frame 17, the front frame 2 and the rear frame 9 move toward the middle of the collapsible cart. Driven by the front frame 2 and the rear frame 9, the front X-shaped folding frames 6 and the rear X-shaped folding frames 8 on both sides synchronously fold. The folding operation is simple, convenient, and fast.

Described above are merely preferred embodiments of the disclosure, which are not intended to limit the disclosure. It should be understood that any modifications and replacements made by those skilled in the art without departing from the spirit of the disclosure should fall within the scope of the disclosure defined by the present claims.

What is claimed is:

1. A double-decker collapsible cart, comprising:
a front frame;
a rear frame;
a first folding mechanism;
a second folding mechanism for double-decker linkage folding;
a front wheel; and
a rear wheel;
wherein the second folding mechanism comprises a front upper base frame, a rear upper base frame, a front lower base frame, a rear lower base frame, and a support linkage rod; the front upper base frame is hingedly connected with the rear upper base frame; and the front lower base frame is hingedly connected with the rear lower base frame;
the front upper base frame and the front lower base frame are hingedly connected to the front frame; the rear upper base frame and the rear lower base frame are hingedly connected to the rear frame; one end of the support linkage rod is hingedly connected to a connection between the front upper base frame and the rear upper base frame; and the other end of the support linkage rod is hingedly connected to a connection between the front lower base frame and the rear lower base frame; and
at least one of the front upper base frame and the rear upper base frame is provided with an openable bottom cover.

2. The double-decker collapsible cart of claim 1, wherein both sides of the double-decker collapsible cart are each provided with the first folding mechanism; the first folding mechanism comprises a front X-shaped folding frame and a rear X-shaped folding frame; and the front X-shaped folding frame is hingedly connected with the rear X-shaped folding frame;
an upper end of a front portion of the front X-shaped folding frame at one side is connected to an upper end of a front portion of the front X-shaped folding frame at the other side; and a lower end of the front portion of the front X-shaped folding frame at one side and a lower end of the front portion of the front X-shaped folding frame at the other side are hingedly connected to the front frame;
an upper end of a rear portion of the rear X-shaped folding frame at one side is connected to an upper end of a rear portion of the rear X-shaped folding frame at the other side; and a lower end of the rear portion of the rear X-shaped folding frame at one side and a lower end of the rear portion of the rear X-shaped folding frame at the other side are hingedly connected to the rear frame; and
a connecting shaft is connected between a lower connection between the front X-shaped folding frame and the rear X-shaped folding frame at one side and a lower connection between the front X-shaped folding frame and the rear X-shaped folding frame at the other side; and the connecting shaft is configured to support the front lower base frame and the rear lower base frame when the double-decker collapsible cart is unfolded.

3. The double-decker collapsible cart of claim 2, wherein a first connecting piece is hingedly connected between the front X-shaped folding frame and the front frame; and
a second connecting piece is hingedly connected between the rear X-shaped folding frame and the rear frame.

4. The double-decker collapsible cart of claim 1, wherein the front frame is provided with an articulation seat; the articulation seat is connected with a pull rod; and the pull rod is configured to be pulled to allow the double-decker collapsible cart to move.

5. The double-decker collapsible cart of claim 2, wherein the front frame is provided with an articulation seat; the articulation seat is connected with a pull rod; and the pull rod is configured to be pulled to allow the double-decker collapsible cart to move.

6. The double-decker collapsible cart of claim 3, wherein the front frame is provided with an articulation seat; the articulation seat is connected with a pull rod; and the pull rod s configured to be pulled to allow the double-decker collapsible cart to move.

7. The double-decker collapsible cart of claim 4, wherein the front frame is provided with two front wheels through a first wheel frame; and the rear frame is provided with two rear wheels through a second wheel frame.

8. The double-decker collapsible cart of claim 5, wherein the front frame is provided with two front wheels through a first wheel frame; and the rear frame is provided with two rear wheels through a second wheel frame.

9. The double-decker collapsible cart of claim 6, wherein the front frame is provided with two front wheels through a first wheel frame; and the rear frame is provided with two rear wheels through a second wheel frame.
